(19) United States
(12) Patent Application Publication
(10) Pub. No.: US 2017/0276331 A1
(43) Pub. Date: Sep. 28, 2017

(54) LIGHT BULB INSERTION GUIDE AND METHOD OF USE

(71) Applicant: COOLEDLITE, INC., Deerfield Beach, FL (US)

(72) Inventors: Peter Ticktin, Boca Raton, FL (US); Thomas Cartwright, Stuart, FL (US)

(21) Appl. No.: 15/081,572

(22) Filed: Mar. 25, 2016

(51) Int. Cl. F21V 19/04; F21S 8/02

(52) U.S. Cl. CPC F21V 19/04; F21S 8/026

(57) ABSTRACT

A centering guide is disclosed that includes a light bulb base coupling member defining an aperture, the aperture size and configured to selectively receive a light bulb base of a light bulb therethrough for selectively coupling the light bulb base coupling member to the light bulb base. A plurality of guide arms may be coupled to the light bulb base coupling member, each guide arm having a proximal end coupled to the light bulb base coupling member; a distal end opposite the proximal end; and a length extending between the proximal end and the distal end, the length extending radially outward from light bulb base coupling member.

### FIELD OF THE INVENTION

The present invention relates generally to light bulb installation, and, more particularly, relates to a method and apparatus for centering a light bulb for installation into a recessed ceiling can.

### BACKGROUND OF THE INVENTION

It is well-known that replacing a light bulb associated with a ceiling can be difficult. In particular, such difficulties increase even further in situations where the light bulb is difficult to access, such as, for example, vaulted ceilings in residential buildings, high ceilings in commercial buildings, and other ceilings disposed in difficult to access areas.

Known methods and devices for aiding users with replacing ceiling light-bulbs include use of a ladder to allow the user to reach the ceiling area for manually screwing and unscrewing light bulbs therein. Unfortunately, many users, both commercial and residential do not possess a ladder with a sufficient height to reach the ceiling area. In addition, there is a safety risk associated with use of ladders to replace light bulbs because users may fall and injure themselves. Ladders are also relatively expensive and, if rented, take time from the user to do so. Additionally, the cost of renting a ladder for each instance in which a light bulb requires replacing can become rather excessive.

Another known method to install a light bulb includes using a pole that acts as an extension arm that allows users to replace ceiling light bulbs, either from the ground, or from a ladder that is insufficient in height to reach the ceiling. Typically, a suction mechanism is disposed on an end of the pole to grip the light bulb. The user grips the other end in order to position the light bulb. Unfortunately, light sockets, receptacles, or ballasts (for brevity, collectively referred to herein as “sockets” or “light sockets”) in ceiling cans are often obscured from view by the user during such replacement. More specifically, the light bulb generally blocks the user's view of the light socket from below such that the user is required to feel around in order to properly insert the light bulb base into the light socket, which is typically centrally disposed within the ceiling can. Unfortunately, it can be difficult to determine where the center of the ceiling can is, especially without a visual cue.

FIG. 1 provides a perspective view of a prior-art light bulb 100 and a ceiling can 102 with a centrally disposed light socket 104. As is apparent from FIG. 1, during installation of the light bulb 100 within the ceiling can 102, a sidewall 106 of the light bulb 100 blocks the user's view of both the light socket 104 and a light bulb base 108 of the light bulb 100. This requires the user to continuously move the light bulb base 108 around within the ceiling can 102 until the user can feel, via his/her tactile senses, that the light bulb base 108 is inserted within the light socket 104, Unfortunately, because it is an imprecise method, this can be a time consuming process. In addition, in situations where the user is standing on a ladder, the longer the user is required to stand on the ladder during the installation of the light bulb 100, the higher the risk that the user will fall and injure himself/herself. Also, the farther the user is from the ceiling 110 and, consequently, the longer the pole 112 is required to be, the more difficult it is to be able to tactically sense that the light bulb base 108 is inserted within the light socket 104.

Therefore, a need exists to overcome the problems with the prior art as discussed above.

### SUMMARY OF THE INVENTION

The invention provides a light bulb insertion guide and method that overcomes the hereinafore-mentioned disadvantages of the heretofore-known devices and methods of this general type and that centers a light bulb for installation within a light socket associated with a recessed ceiling can.

With the foregoing and other objects in view, there is provided, in accordance with the invention, a centering guide for light bulb insertion within a recessed ceiling can, the centering guide including a light bulb base coupling member operably configured to selectively couple the light bulb base coupling member to a light bulb base of a light bulb; and at least one guide arm coupled to the light bulb base coupling member and operably configured to center the light bulb as the light bulb is translated in a vertical direction toward a light socket associated with a recessed ceiling can when the light bulb base coupling member is coupled to the light bulb base of the light bulb. The guide arm may have a proximal end coupled to the light bulb base coupling member; a distal end opposite the proximal end; and a length extending between the proximal end and the distal end, the length extending radially outward from light bulb base coupling member.

In accordance with another feature of the present invention, the light bulb base coupling member defines an aperture, the aperture sized and configured to selectively receive the light bulb base therethrough for selectively coupling the light bulb base coupling member to the light bulb base.

In accordance with another feature of the present invention, the guide arm includes a plurality of guide arms.

In accordance with a further feature of the present invention, each of the plurality of guide arms are fixedly attached to the light bulb base coupling member.

In accordance with an additional feature of the present invention, the length of at least one of the plurality of guide arms is less than the length of another one of the plurality of guide arms.

In accordance with yet another feature of the present invention, the plurality of guide arms includes a first subset of guide arms with a corresponding first length, a second subset of guide arms with a corresponding second length, and the first length different from the second length.

In accordance with another feature of the present invention, the plurality of guide arms are arranged such that the guide arms of the corresponding first length alternate with the guide arms of the corresponding second length along the light bulb base coupling member.

In accordance with yet another feature of the present invention, the light bulb base coupling member is circular and at least a portion of each of the plurality of guide arms are disposed along an outer circumference of the light bulb base coupling member and extending radially outward therefrom.

In accordance with another feature of the present invention, the plurality of guide arms are disposed along an outer perimeter of the light bulb base coupling member and equally spaced apart from one another along said outer perimeter.

In accordance with another feature of the present invention, the distal end is operably configured as a recessed ceiling can sidewall engaging end.

In accordance with another feature of the present invention, the guide arm is of a resilient material.

In accordance with yet another feature of the present invention, the centering guide is sized to include a width that is substantially the same as a width of the recessed ceiling can.

In accordance with a further feature of the present invention, the length of the guide arm extends radially outward in a substantially linear direction within a horizontal plane when the guide arm is not in a flexed configuration.

In accordance with another feature of the present invention, an exterior surface of the at feast one guide arm is substantially planar along its length.

In accordance with another feature, an embodiment of the present invention includes a method of inserting a light bulb into a light socket of a recessed ceiling can. The method includes providing, by a user, a centering guide with a light bulb base coupling member; and a plurality of guide arms coupled to the light bulb base coupling member, each of the guide arms having a proximal end coupled to the light bulb base coupling member, a distal end opposite the proximal end, and a length extending between the proximal end and the distal end. The user couples the centering guide to a light bulb base of a light bulb. After coupling the centering guide to the light bulb base of a light bulb, the user translates the light bulb coupled to the centering guide in a vertical direction toward a light socket associated with a recessed ceiling can. During the translating step, distal ends of at least a first one and a second one of the plurality of guide arms engaging an interior surface of a sidewall of the recessed ceiling can so as to guide the user in a radial direction toward a central axis of the recessed ceiling can.

In accordance with yet another feature, an embodiment of the present invention includes providing the light bulb base coupling member defining an aperture; and inserting, by the user, the light bulb base through the aperture.

In accordance with yet a further feature of an embodiment of the present invention, during the translating step, distal ends of at least a third one and a fourth one of the plurality of guide arms flexing as a result of engaging the interior surface of the sidewall of the recessed ceiling can.

In accordance with yet another feature, an embodiment of the present invention includes the user coupling the light bulb to the light socket by screwing the light bulb base into the light socket.

In accordance with another feature, an embodiment of the present invention includes providing a length of at least one of the plurality of guide arms as less than a length of another one of the plurality of guide arms.

In accordance with yet another feature, an embodiment of the present invention includes providing the light bulb base coupling member defining an aperture; sliding, by the user, in a linear direction, the light bulb base through the aperture defined by the light bulb base coupling member.

Although the invention is illustrated and described herein as embodied in a light bulb insertion guide and method of use, it is, nevertheless, not intended to be limited to the details shown because various modifications and structural changes may be made therein without departing, from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein, are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

As used herein, the terms “about” or “approximately” apply to all numeric values, whether or not explicitly indicated. These terms, generally refer to a range of numbers that one of skill in the art would consider equivalent to the recited values (i.e., having the same function or result). In many instances these terms may include numbers that are rounded to the nearest significant figure. In this document, the term “longitudinal” should he understood to mean in a direction corresponding to an elongated direction of the light bulb from a bottom of the light bulb to the light bulb base.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a upward-looking perspective view of a prior-art step of installing a light bulb within a recessed ceiling can;

FIG. 2 is a perspective view of a centering guide in accordance with an embodiment of the present invention;

FIG. 3 is a downward-looking perspective view of the centering guide of FIG. 2 coupled to a light bulb, in accordance with an embodiment of the present invention;

FIG. 4 is an enlarged downward-looking perspective view of FIG. 3, in accordance with an embodiment of the present invention;

FIG. 5 is a top plan view of another exemplary embodiment of a centering guide, having guide arms of varying lengths, in accordance with the present invention;

FIG. 6 is a downward-looking perspective view of the centering guide of FIG. 5 coupled to a light bulb, in accordance with an embodiment of the present invention;

FIG. 7 is a flow chart of an exemplary method of inserting a light bulb into a recessed ceiling can, in accordance with the present invention;

FIG. 8 is a downward-looking perspective view of the centering guide of FIG. 5 being coupled to a light bulb, in accordance with an embodiment of the present invention;

FIG. 9 is a perspective view of a user inserting a light bulb coupled to a centering guide into a ceiling can, in accordance with an embodiment of the present invention;

FIGS. 10 and 11 are partially cross-sectional elevation side views illustrating insertion of the centering guide of FIG. 5 in a ceiling can, in accordance with an embodiment of the present invention;

FIG. 12 is a partially cross-sectional elevation side view illustrating coupling of the light bulb with a light socket of the ceiling can, in accordance with an embodiment of the present invention; and

FIG. 13 is a cross-sectional elevation view of an alternative embodiment of a centering guide, in accordance with an embodiment of the present invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that, the disclosed embodiments are merely exemplary of the invention, which can be embodied in various forms.

The present invention provides a novel and efficient centering guide for a light bulb when insertion within a recessed ceiling can is desired. Embodiments of the invention provide a light bulb base coupling member with a plurality of guide arms extending from the light bulb base coupling member, the plurality of guide arms operably configured to guide a light bulb toward a center of a recessed ceiling can during installation of the light bulb within the recessed ceiling can. In addition, embodiments of the invention provide the light bulb base coupling member shaped as a collar defining an aperture through which the light bulb base is inserted for selectively coupling of the centering guide with the light bulb. Further, embodiments of the centering guide include guide arms made of a resilient material and provided in varying lengths to accommodate use with ceiling cans of varying diameters.

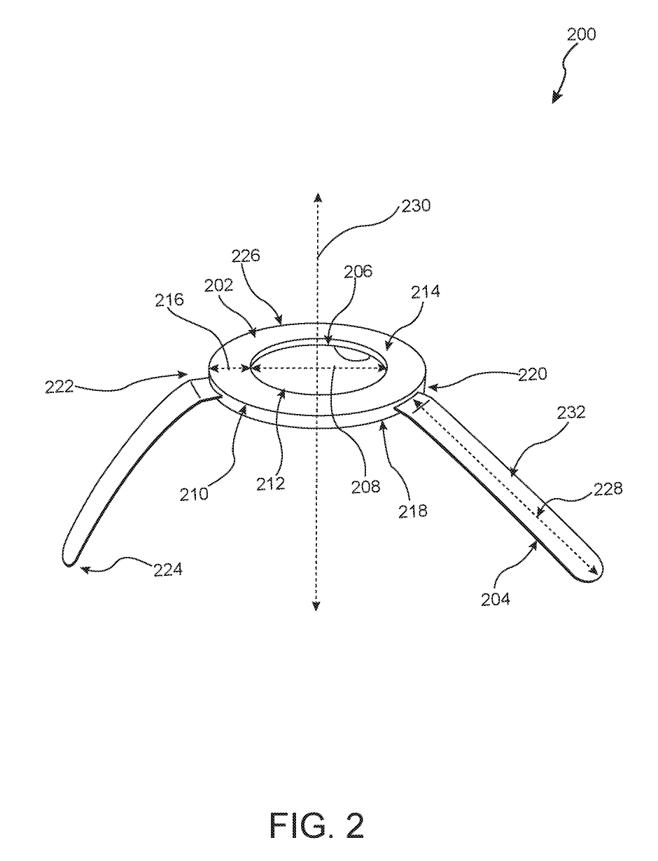

Referring now to FIG. 2, one embodiment of the present invention is shown in a perspective view. FIG, 2 shows several advantageous features of the present invention, but, as will be described below, the invention can be provided in several shapes, sizes, combinations of features and components, and varying numbers and functions of the components. The first example of a centering guide 200, as shown in FIG. 2, includes a light bulb base coupling member 202 and at least one guide arm 204 coupled thereto. In one embodiment, there are a plurality of guide arms 204 extending outwardly from the light bulb base coupling member 202.

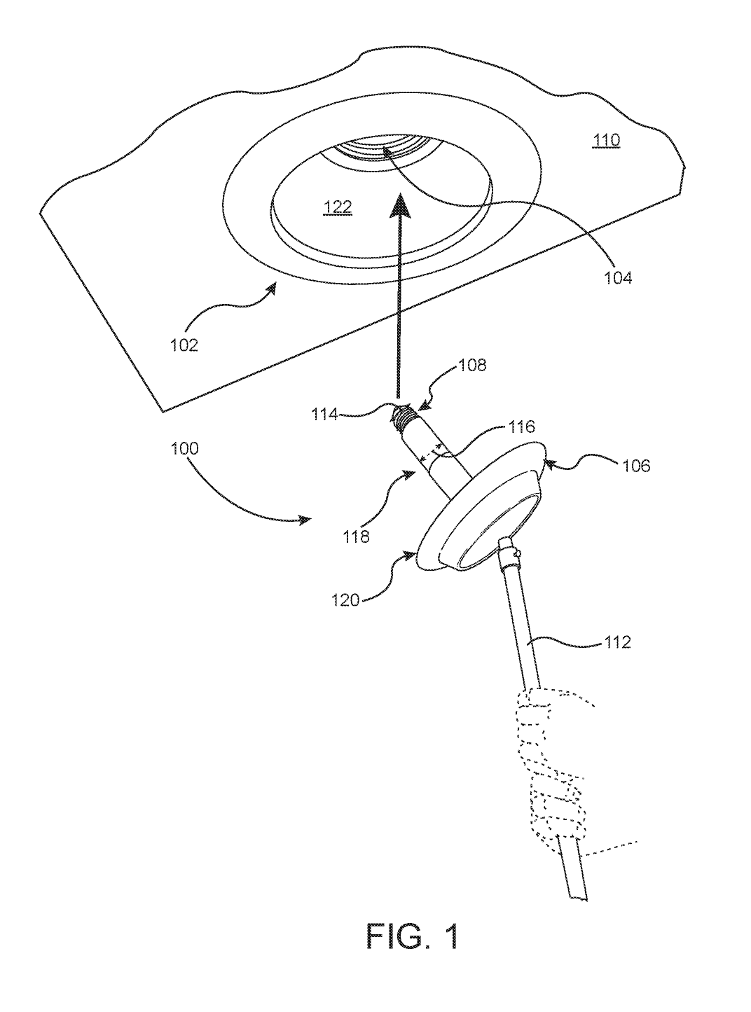

In one embodiment, with reference also to FIG. 1, the light bulb, base coupling member 202 is circular. In another embodiment, the light bulb base coupling member 202 is oval-shaped. In yet another embodiment, the light bulb base coupling member 202 may be provided in other shapes. In one embodiment, the light bulb base coupling member 202 may define an aperture 206. The aperture 206 can be considered a through-hole, through which at least a portion of the light bulb 100 may be inserted for selectively coupling of the light bulb base coupling member 202 to the light bulb 100. In another embodiment, the aperture 206 is sized to selectively receive the light bulb base 108 of the light bulb 100 therethrough for selectively coupling the light bulb base coupling member 202 to the light bulb base 108. As used herein, the term “light bulb” is intended, to indicate a light-emitting device associated with a light bulb base and intended for use as a tamp or a light source for a light fixture with a light socket couplable to the light bulb base. The term “light bulb” is not intended to be limited to incandescent light bulbs, and may include light-emitting diode bulbs (LED), fluorescent bulbs, among others.

It is understood that although the figures depicted herein, illustrate one or more particular types of light bulbs, embodiments of the present invention may be sized, shaped, and operably configured so as to operable with any known type of light bulb, in accordance with the present invention. In other words, the present invention is not intended to be restricted to any particular type of light bulb. As is known in the art, there are a wide variety of light bulbs, in many configurations, including but not limited to halogen, LED, incandescent, fluorescent, etc. In addition, there are a multitude of known bulb shapes and sizes (e.g., A series, PS series, B series, C series, R series, BR series, etc) and bases (e.g., E10, E26, G9, G12, G-23, screw bases, pin bases, plug-in bases, specialty bases, etc.) and embodiments of the present invention are not intended to be limited tor use with any one particular shape, size, or base, unless, otherwise clearly and expressly indicated herein. One or more embodiments of the present invention may be configured, for use with the most widely used, or one of the most widely used, bases and bulb shapes/sizes, such as, for example, an E26 base.

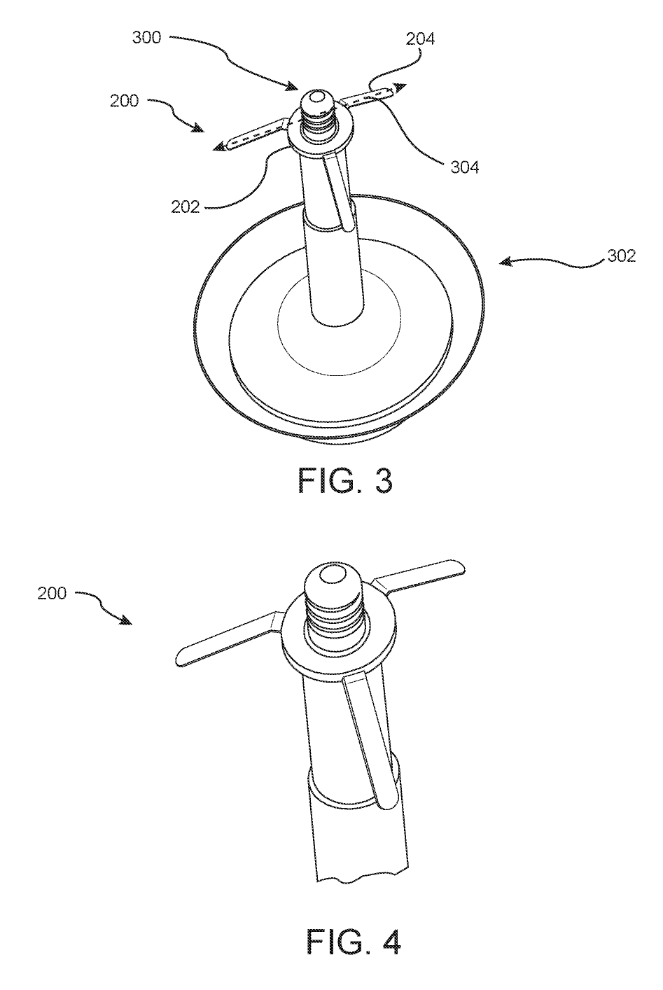

In one embodiment, the aperture 206 defines a diameter 208. In a further embodiment, the diameter 208 may be greater than a width or diameter 114 of the light bulb base 108 so that the light bulb base 108 is able to pass through the aperture 206 in accordance with the present invention. In yet a further embodiment, the diameter 208 may also be less than a width 116 of at least a portion 118 of the light bulb 100 such that the light bulb base coupling member 202 is able to rest on the portion 118 of the light bulb 100 (see FIG. 3 and corresponding description herein). For example, the portion 118 may be a shaft extending between a light source housing 120 and the light bulb base 108. In another embodiment, the portion 118 may be formed as a glass housing for the light source. In yet other embodiments, the portion 118 on which the light bulb base coupling member 202 rests may be provided as other portions of the light bulb 100 (e.g., top wall or sidewall of the light source housing 120). In one embodiment, the aperture 206 is considered sized and configured such that the user is able to selectively couple the centering guide 200 to the light bulb 100 by sliding the light bulb base coupling member 202 over the light bulb base 108 and allowing the centering guide 200 to rest on the portion 118 of the light bulb 100.

In one embodiment, the light bulb base coupling member 202 is configured so as to allow the user to selectively couple the centering guide 200 to the light bulb 100 in other ways. For example, in one embodiment, the light bulb base coupling member 202 may include a substrate with an adhesive substance provided thereon for adhering the light bulb base coupling member 202 to the light bulb 100. Preferably, the adhesive substance is a heat-resistant resin, or other heat-resistance adhesive. In an alternative embodiment, the light bulb base coupling member 202 may include a snap-on device for coupling the centering guide 200 to the light bulb 100 in a snap configuration. In other embodiments, the light bulb base coupling member 202 may be configured to provide a friction fit with a portion of the light bulb 100. In further embodiments, the light bulb base coupling member 202 may be provided in other coupling configurations or may be formed as part of the light bulb 100.

In one embodiment, the light bulb base coupling member 202 is made of a plastic material. Preferably, the light bulb base coupling member 202 is made of a heat-resistant material that can withstand prolonged exposure the heat from the light bulb 100. In one embodiment, the light bulb base coupling member 202 is of a non-conductive material, such as a non-conductive polymer material. In another embodiment, the light bulb base coupling member 202 is of a glass material. In yet another embodiment, the light bulb base coupling member 202 may be made of other types of known heat-resistant materials.

Advantageously, the light bulb base coupling member 202 is operably configured to allow a user to quickly and easily couple and uncouple the centering guide 200 to the light bulb 100. More specifically, an advantage of the centering guide 200 is that, in use, the user can easily and quickly uncoupled the centering guide 200 from a non-operative light bulb 100 and, subsequently, quickly, and easily couple it to a replacement light bulb 100 that requires installation within the ceiling can 102. As used herein, the term “recessed ceiling can” and “ceiling can” are used interchangeably and are intended to indicate a recessed portion of a ceiling that defines a receiving area for a light fixture.

In one embodiment, the light bulb base coupling member 202 defines an outer perimeter 210. In a further embodiment, in which the coupling member 202 is circular-shaped, the outer perimeter 210 can be considered an outer circumference 210 of the light bulb base coupling member 202. In one embodiment, the diameter 208 of the aperture 206 can be considered to be defined by an inner circumference 212 of the light bulb base coupling member 202. In another embodiment, a portion of the light bulb base coupling member 202 extending between and defined by the inner circumference 212 and the outer circumference 210 is operable as a gripping surface 214 for the user to grip as he/she couples the centering guide 200 to the light bulb 100. In one embodiment, the gripping surface 214 may include a width 216 that is about a width of an average user's thumb. In other embodiments, the width 216 may be greater than, or less than the average user's thumb.

In one embodiment, the light bulb base coupling member 202 may include a top surface 214 and a bottom surface 218, opposite the top surface 214. In one embodiment, the gripping surface 214 may include the bottom and top surfaces 218, 214 for user gripping with both the thumb and index finger. In another embodiment, the bottom and top surfaces 218, 214 may be completely or partially planar. In other embodiments, the bottom and top surfaces 218, 214 may also be non-planar (e.g., such surfaces may include ridges or protrusions, and/or may include curved surfaces). In one embodiment, the bottom and top surfaces 218, 214 may be parallel with one another. In another embodiment, the light bulb base coupling member 202 may include at least one sidewall surface 220 interposed between the bottom and top surfaces 218, 214 and generally perpendicular thereto. In a further embodiment, the sidewall surface 220 may be substantially perpendicular (90 degrees+/−15 degrees) to the bottom and/or top surface(s) 218, 214. In other embodiments, the sidewall surface 220 may be provided in other orientations with respect to the bottom and/or top surface(s) 218, 214. In further embodiments, the light bulb base coupling member 202 may be considered to include a plurality of sidewall surfaces 220 disposed between bottom and/or top surface(s) 218, 214. In one embodiment, the sidewall surface 220 may be curved. In other embodiments, the sidewall surface 220 may be considered linear, or rectilinear.

Still referring to FIGS. 1-2, in one embodiment the guide arm 204 is coupled to the light bulb base coupling member 202. A large portion of the discussion below will describe various embodiments of a single guide arm 204. However, it is understood that such features may also describe each of a plurality of guide arms 204 that are coupled to the light bulb base coupling member 202. It is also understood that, in some embodiments, the guide arms 204 are integrated with (unitary) the light bulb base coupling member 202 (e.g., through injection, molding) and, in other embodiments, the guide arms 204 are removably coupled to the light bulb base coupling member 202.

In one embodiment, the guide arm 204 may have a proximal end 222 and a distal end 224 opposite the proximal end 222. The term “end,” unless otherwise expressly stated herein, is defined herein to mean a location at or approximately one to three inches away from a plane containing the absolute end of a structure. In one embodiment, the proximal end 222 is coupled to the light bulb base coupling member 202. In a further embodiment, the proximal end 222 may be coupled to the light bulb base coupling member 202 by any known method, such as, for example, an adhesive, injection molding, hook-and-loop attachments, a friction fit, a snap configuration, a male-female/tongue-and-grove attachment mechanism, and the like.

The distal end 224 may be considered a ceiling can sidewall engaging end. Stated another way, the distal end 224 may be considered a free end that is configured to engage/touch an interior surface 122 of a sidewall 124 of the ceiling can 102 so as to tactilely alert that user that the light bulb 100 is moving off center. To elaborate, at least one distal end 224, but preferably at least three distal ends 224 of the plurality of guide arms 204, is operably configured to engage the interior surface 122 of the ceiling can 102 when the light bulb 100 begins to move off center. Accordingly, the user is alerted to translate the light bulb 100 back towards the center of the ceiling can 102.

In one embodiment, the guide arm 204 may be elongated in shape. In an alternative embodiment, the guide arm 204 may be non-elongated in shape. In another embodiment, the guide arm 204 may include curved ends 222, 224. In another embodiment, the guide arm 204 may include linear ends 222, 224. In one embodiment, the guide arm 204 may be disc-shaped (e.g., circular). In another embodiment, the guide arm 204 may be disc-shaped and disposed so as to be substantially concentric with the light-bulb base 108. In yet a further embodiment, the guide arm 204 may be disc-shaped with a radius sized such that the distal end 224 is configured to contact a sidewall of the ceiling can 102 when the user to begins to translate the light-bulb base 108 off-center within the ceiling can 102, during installation. In other embodiments, the guide arm 204 may be other shapes, sizes, and configurations.

In an embodiment in which the light bulb base coupling member 202 is circular, at least a portion of each of the guide arms 204 may be disposed along an outer circumference 226 of the light bulb base coupling member 202. In a further embodiment, at least a portion of each of the plurality of guide arms 204 extends radially outward from the light bulb base coupling member 202. In an embodiment in which the light bulb base coupling member 202 is not considered circular, at least a portion of each of the plurality of guide arms 204 can be considered disposed along an outer perimeter 226 of the light bulb base coupling member 202. In another embodiment, each of the plurality of guide arms 204 can be equally spaced apart from one another along the outer perimeter 226. In yet another embodiment, each of the plurality of guide arms 204 may be unequally spaced apart from one another along the outer perimeter 226.

In one embodiment, each of the plurality of guide arms 204 may be fixedly attached to the light bulb base coupling member 202. As used herein, the term, “fixedly attached” is intended to indicate an attachment of the guide arms 204 to the light bulb base coupling member 202 that Is not intended to permit rotation, sliding or pivoting movement of the guide arms 204 relative to the light bulb base coupling member 202, at the attachment area. The term “fixedly attached” does, however, allow for flexing movement of the guide arms 204 in certain embodiment in which the guide arms 204 are of a flexible material. Specifically, some embodiments of the present invention allow for the guide arms 204 to bend or flex when portions of the guide arms 204 contact/engage/touch the sidewall 124 of the ceiling can 102 as it is being translated by the user, as explained in more detail below.

The one or more guide arms 204 may be made of a metallic material. In one embodiment, the guide arm 204 is of a heat-resistant material. In another embodiment, the guide arm 204 includes a resilient material, such as a spring-biased material. In such an embodiment in which the guide arm 204 includes a resilient material, as the user inserts the light bulb 100 into the ceiling can 102, portions of guide arms 204 may bend or flex. In yet another embodiment, the guide arm 204 is of a pliable material. In other embodiments, the guide arm 204 may be made of other types of materials.

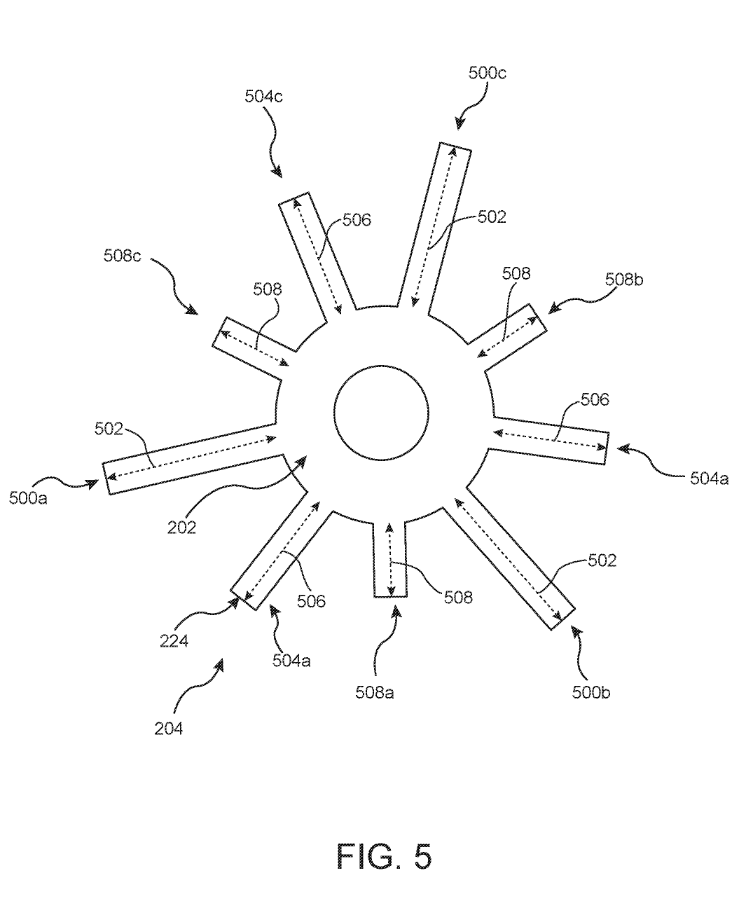

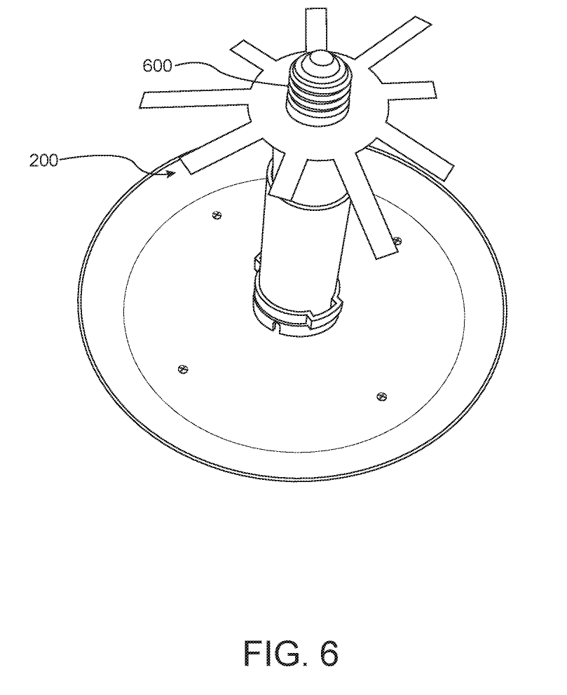

In one embodiment, the centering guide 200 includes a length 228 that extends from the proximal end 222 to the distal end 224. In one embodiment, the length 228 extends along a linear path. In another embodiment, the length 228 extends in a non-linear path (e.g. zig-zag, curved, rectilinear). In one embodiment, the length 228 extends radially outward from the light bulb base coupling member 202, as depicted in the exemplary embodiment. In one embodiment, at least a portion of the length 228 of the guide arm 204 may also extend in an axial direction. In other words, the guide arm 204 may curve or bend in an axial direction. As used herein, unless otherwise expressly stated herein, the terms “radial” and “radially” are defined as lines or directions radially toward or away from a central axis 230 of the light bulb base coupling, member 202, where the central axis 230 may be considered an axis of rotation for a circular-shaped light bulb base coupling member 202. As used herein, the term “axial” and “axially” is intended to indicate lines or directions that are parallel to the central axis 230 (or the axis of rotation 230 for a circular-shaped light bulb base coupling member 202). In one embodiment, the length 228 of each of the plurality of guide arms 204 is the same. In another embodiment, the length 228 of at least one of the plurality of guide arms 204 is less than the length 228 of another one of the plurality of guide arms 204, as will be discussed herein in more detail below with reference to FIGS. 5 and 6.

In one embodiment, the length 228 of the guide arm 204 may be sized such that, when the light bulb 100 is within the ceiling can 102 and the user begins to move the light bulb 100 off center, the distal end 224 of the guide arm 204 contacts the sidewall 124. Stated another way, the plurality of guide arms 204 may be operably configured, so as to center the light bulb 100 as the light bulb 100 is translated in a vertical direction toward the light socket 104 of a light fixture associated with the recessed ceiling, can 102 when the light bulb base coupling member 202 is coupled to the light bulb base 108 of the light bulb 100.

In one embodiment the length 228 of each of the plurality of guide arms 204 extends radially outward in a substantially linear direction when the guide arms 204 are not in a flexed configuration. Stated another way, the length 228 of each of the plurality of guide arms 204 may lie substantially (100%+/−15%) within, and may be parallel to, the same plane defined by one or both of the surfaces 214, 218 when the guide arms 204 are not in a flexed configuration. In yet another embodiment, an exterior surface 232 of each of the plurality of guide arms 204 is substantially planar along its length 228. In an alternative embodiment, the exterior surface 232 may include ridges, or other projections so as to be considered a non-planar surface.

Referring now briefly to FIGS. 3 and 4, an exemplary embodiment of the centering guide 200 is shown coupled to a light bulb base 300 of a light bulb 302. When desired for use to couple the centering guide 200 to the light bulb base 300, the user may slide or place the light bulb base coupling member 202 over the light bulb base 300 such that at least a portion of the light bulb base 300 passes through the aperture 206. Accordingly, the light bulb base coupling member 202 may rest on a portion of the light bulb 302 so that in such resting position the guide arms 204 extend radially outward. The centering guide 200, including the guide arms 204 and the light bulb base coupling member 202, is sized to include a width 304 that is substantially (100% +/-15%) a width of a standard-sized recessed ceiling can. In one embodiment, the centering guide 200 includes a width of at least 3 inches. In another embodiment, the centering guide 200 includes a width of about 4 inches. In another embodiment, the centering guide 200 includes a width of at least 6 inches. In another embodiment, the centering guide 200 includes a width of about 6 inches. In yet another embodiment, the centering guide 200 may be sized outside of these ranges depending on the guide's application.

Referring now briefly to FIGS. 5 and 6, in one embodiment, the plurality of guide arms 204 can be segmented into at least two subsets of guide arms 204, each of the subsets of guide arms 204 having a length different than a length of the other ones of the subsets of guide arms 204, with each subset having guide arms 204 of the same length. Stated another way, a first subset 500a-n of the plurality of guide arms 204 can have a corresponding first length 502; a second subset 504a-n of the plurality of guide arms 204 can have a corresponding second length 506; and the first length 502 can be different from the second length 506. The number of guide arms 204 in each subset between “a” and “n” can be any number. In a further embodiment, the plurality of guide arms 204 can be arranged such that the guide arms 204 of the first length 502 alternate with the guide arms 204 of the second length 506 along the light bulb base coupling member 202. In a further embodiment, there can be a third subset 508a-n with a corresponding third length 510, wherein the third length 510 is different from the first length 502 and the second length 506. In one embodiment, the plurality of guide arms 204 can be arranged such that the guide arms 204 of the first length 502, second length 506, and third length 510 alternate with one another along the light bulb base coupling member 202, as depicted in the exemplary embodiment of FIG. 5. FIG. 6 shows the centering guide 200 with the length-varying guide arm subsets 500, 504, and 508 coupled to a light bulb base 600.

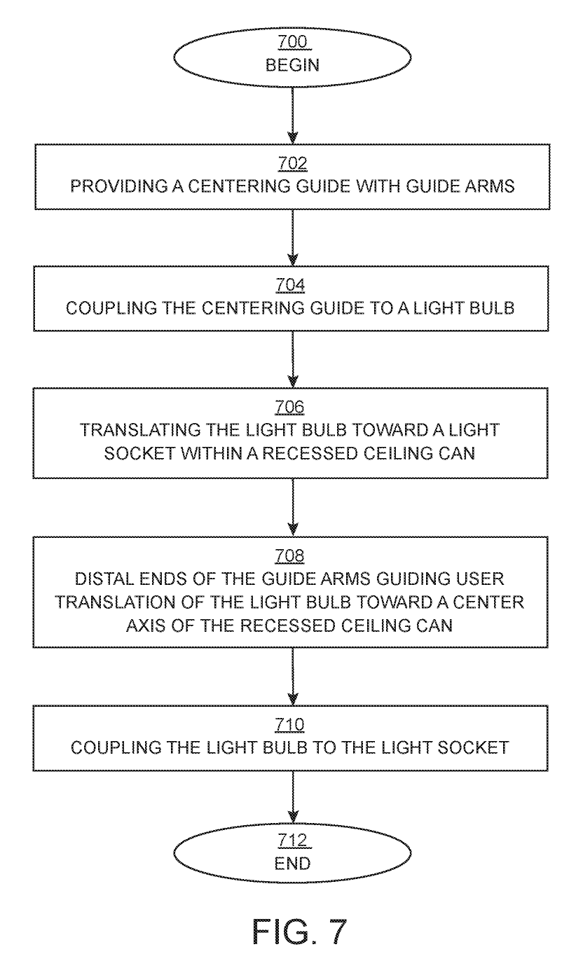

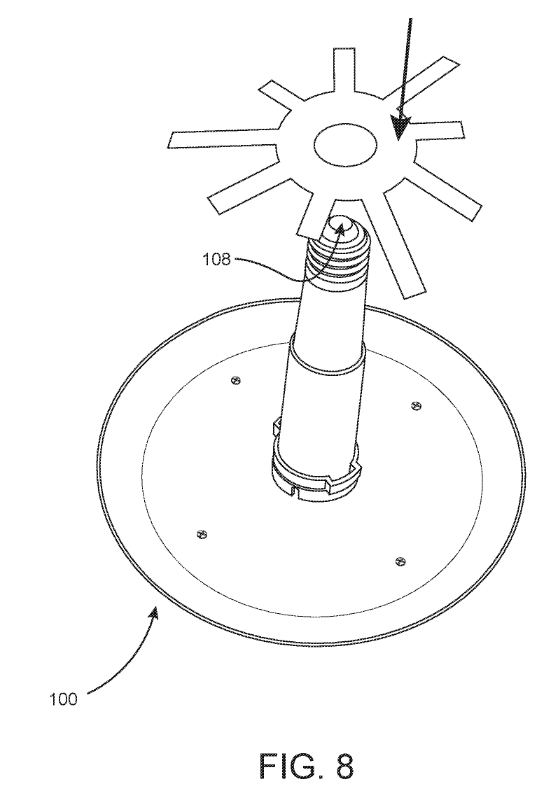

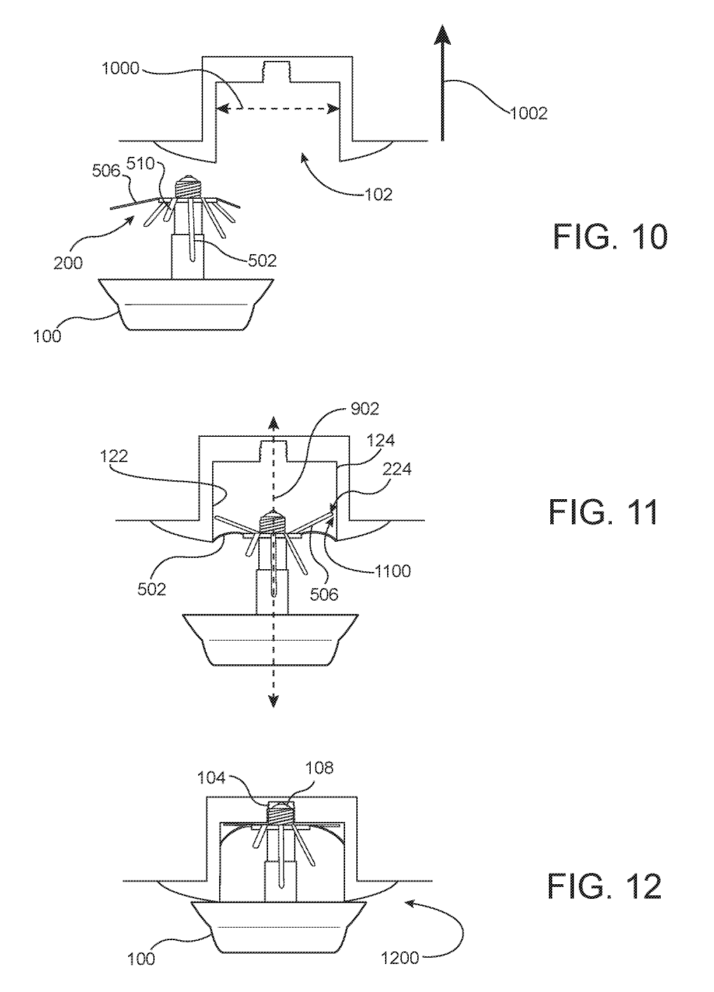

FIGS. 8-12 will be described, in. conjunction with the process flow chart of FIG. 7. Although FIG. 7 shows a specific order of executing the process steps, the order of executing the steps may be changed relative to the order shown in certain embodiments. Also, two or more blocks shown, in succession may be executed concurrently or with partial concurrence in some embodiments. Certain steps may also be omitted in FIG. 7 for the sake of brevity.

The process of FIG. 7 begins at step 700 and moves directly to step 702, where a user provides the centering guide 200 having guide arms 204 coupled to the light bulb base coupling member 202, which defines the aperture 206, as illustrated in FIG. 8. It is understood that with respect to the process of installing a light bulb within a ceiling can using the centering guide 200, the “user” is an end-user, consumer of the centering guide 200, and, not, for example, a manufacturer of the light bulb or the centering guide 200.

In step 704, the user couples the centering guide 200 to the light bulb 100. More specifically, the user may couple the centering guide 200 to the light bulb base 108 of the light bulb 100. In one embodiment, the user may insert the light bulb base 108 through the aperture 206. In a further embodiment, the user may slide the light bulb base 108 through the aperture 206 in an axial direction until the centering guide 200 is able to rest on a portion of the light bulb 100. In another embodiment, the user may couple the centering guide 200 to the light bulb base 108 by coupling the centering guide 200 to another portion of the light bulb 100 (e.g., shaft, light-source housing, or other portion). In yet another embodiment, the user may couple the centering guide 200 to the light bulb base 108 via another attachment method or apparatus, such as a hook-and-loop fastener, an adhesive, a snap mechanism, a friction fit, or the like.

In step 706, the user may translate the light bulb 100 coupled to the centering guide 200 in a vertical direction 900 toward the light socket 104 associated with the recessed ceiling can 102. In other words, the user may lift or raise the light bulb 100 coupled to the centering guide 200 toward the light socket 104 in the recessed ceiling can 102. In one embodiment, the user may perform this step on a ladder. In another embodiment, the user may utilize an extension pole, or other extension mechanism. In yet another embodiment, the user may utilize his/her hands to manually grip and lift the light bulb 100 toward the ceiling can 102.

In step 708, distal ends 224 of the guide arms 204 may guide the user's translation of the light bulb 100 toward a central axis 902 of the recessed ceiling can 102. In a further embodiment, distal ends 224 of at least two of the guide arms 204 may engage the interior surface 122 of the sidewall 124 of the ceiling can 102 so as to guide the user in a radial direction 904 toward the central axis 902 of the recessed ceiling can 102. Here, the radial direction 904 is intended to indicate directions radially toward the central axis 902 of the recessed ceiling can 102. To elaborate, light sockets in ceiling cans 102 are typically disposed along the central axis 902 of the ceiling can 102. Accordingly, it is advantageous to use the centering guide 200 to assist the user in inserting the light bulb 100 within the centrally disposed light socket 104. This reduced the time and hassle associated with replacing and installing light bulbs 100 within a ceiling. It may also reduce the risk of a fall or other injury, because less effort and time need be expended to locate the center of the ceiling can 102, particularly where the user is on a ladder.

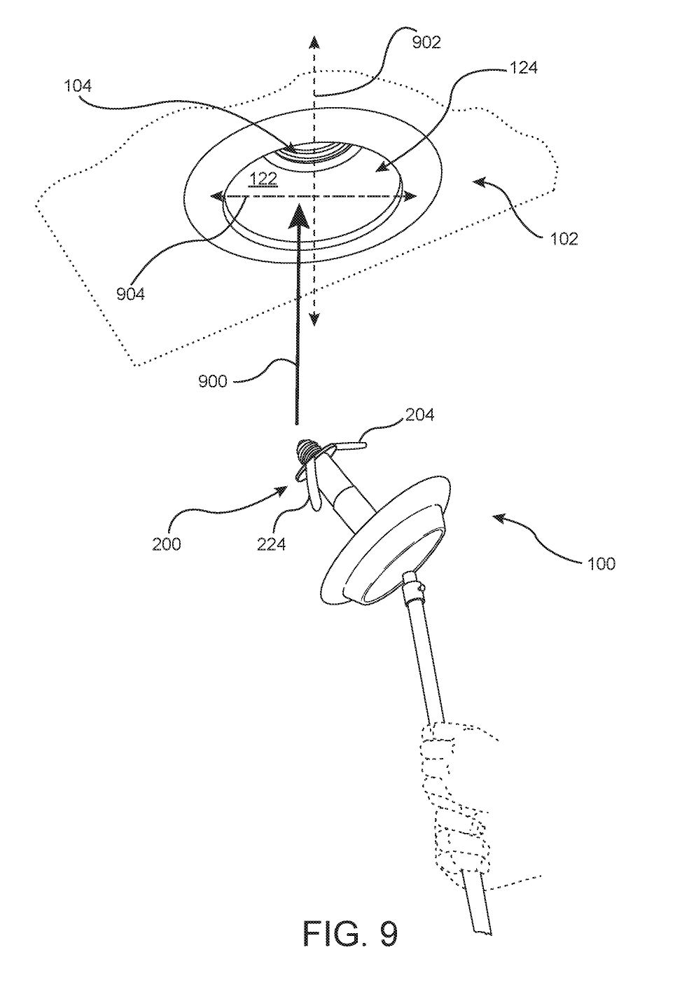

Generally, ceiling cans can be provided with differing widths or diameters. Accordingly, in one embodiment, the centering guide 200 may be advantageously configured with length-varying guide arm subsets 500, 504, and 508, as illustrated in FIGS. 5 and 6. Each subset 500, 504, 508 may be configured to guide insertion of light bulbs into diameter-varying ceiling cans. Referring now again briefly to FIGS. 5 and 6, with brief reference to FIG. 9, an example is described. In an embodiment, the first length 502 may be sized to guide insertion of light bulbs into a first type of ceiling can having a first diameter. In other words, the first length 502 is sized and configured such that when the light bulb 100 is within the ceiling can 102 and the user begins to move the light bulb 100 off-center, the distal end 224 of the guide arm 204 having said first length 502 contacts the sidewall 124 of the can. Such physical contact tactilely alerts the user to move the light bulb 100 radially back towards the central axis of the ceiling can 102. Likewise, the second length 506 is sized to guide insertion of light bulbs into a second type of ceiling can having a second diameter, different from the first diameter, as explained above with reference to the first length 502. In addition, the third length 510 may be sized to guide insertion of light bulbs into a third type of ceiling can having a third diameter, different front the first and the second diameter, as explained above with reference to the first length 502. In a further embodiment, the centering guide 200 may include more than three subsets 500, 504, and 508 when, for example, the cross-sectional geometry of the can varies.

In one embodiment, the guide arms 204 may be removable so that the user can selectively utilize the appropriate corresponding guide arm subset 500, 504, 508 for the particular ceiling can that the user desires to replace a light bulb in. In another embodiment, the guide arms 204 may be of a resilient or pliable material such that guide arms 204 that are longer in length than required for the particular ceiling can will flex or bend as a result of engaging the interior surface 122 of the sidewall 124 of the recessed ceiling can 102. As used herein, the term “engage” is defined as touching or physically contacting something. Such an embodiment will be described now, with reference to FIGS. 10-11 and 5-6, in one example implementation. In the exemplary implementation, the second length 506 is sized to guide insertion of the light bulb 100 into the ceiling can 102, which may have a diameter of, for example, 6 inches. The first length 502, on the other hand, may be sized to guide insertion of the light bulb 100 into a ceiling can 102 having a diameter of, for example, 8 inches. The third length 510 may be sized to guide insertion of the light bulb 100 into a ceiling can 102 having a diameter of, for example, 4 inches. The diameter 1000 of the depicted ceiling can 102 may be 6 inches. Accordingly, as the user translates the light bulb 100 coupled to the centering guide 200 in a vertical direction 1002 toward the ceiling can 102, the guide arm subset 500 having the first length 502 will flex or bend as it engages the interior surface 122 of the sidewall 124 of the ceiling can 102. On the other hand, the guide arm subset 504 having the second length 506 will be sized such that when the light bulb 100 is disposed within the ceiling can 102, the interior surface 122 of the sidewall 124 and each of the distal ends 224 of the guide arm subset 504 defines a relatively small gap 1100. In one embodiment, the gap 1100 is at least one inch. In another embodiment, the gap 1100 may be less than or greater than one inch. The gap 1100 may be of a size such that when the user begins to translate the light bulb 100 away from the central axis 902, the distal ends 224 tap the interior surface 122, thereby alerting the user to move the light bulb 100 back towards the center. Accordingly, the user is tactilely guided toward the center of the ceiling can 102. Of course, with a ceiling can 102 having a diameter of 4 inches, the first length 502 and the second lengths 506 are flexed and bent, with third length 510 operable to tap the sidewall 124, thereby guiding the user towards the center of the 4-inch ceiling can 102. It is understood that diameters of 4, 6, and 8 inches are selected merely for illustrating one application of the present invention. As such, said diameters and lengths are not intended to be limited to said lengths.

Referring now to FIG. 12, in step 710, the user couples the light bulb 100 to the light socket 104. In one embodiment, the user couples the light bulb 100 to the light socket 104 by screwing the light bulb base 108 into the light socket 104 in either a clockwise or a counter-clockwise direction 1200. In other embodiments, the user may couple the light bulb 100 to the light socket 104 by other coupling mechanisms. Of course, such coupling may depend on the type and configuration of the light bulb base 108 and the corresponding configuration of the light socket 104. In an alternative embodiment, the user may couple, the light bulb 100 to the light socket 104 via a pin attachment system, or another type of known attachment system. In one embodiment, the centering guide 200 remains coupled to the light bulb 100 while the light bulb 100 is coupled to the light socket 104. The centering guide 200 may be removed from the light bulb 100 when the user is ready to replace said light bulb 100. To accommodate effective and efficient removal of the centering guide 200, the arms 204 may be of a flexibility to permit the entire arm 204 or a portion of the arm 204 to be disposed at an orientation substantially parallel (within +/−15°) to the central axis 902 of the can 102 or the central axis 230 of the light bulb 100. Said another way, the arms 204 may be operable to be flexed and oriented during removal at an inverted orientation to the orientation of the arms 204 when they are inserted into the can 102. As such, should the can 102 have an protrusion(s) or recess(es) along a bulb 100 and guide 200 removal path, that would otherwise inhibit said removal (because the arms may be biased to supply compression forces against the sidewall 124 of the can 102), the arms 204 may be operable to flex and/or deform to allow the bulb 100 and guide 200 to be removed. Said even further, the arms 204 may have a range of motion or flexibility of approximately 180° with respect to the outer perimeter 210 of the guide 200. The process immediately ends at step 712.

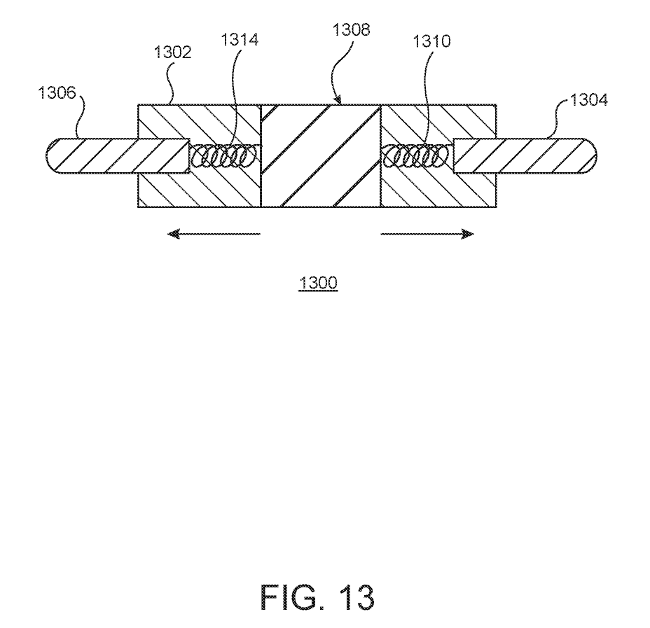

Referring now to FIG. 13, yet another alternative embodiment for a centering guide 1300 is depicted in a cross-sectional view. The centering guide 1300 may include a circular light bulb base coupling member 1302 and at least two arms 1304, 1306 extending radially outward therefrom. The centering guide 1300 may define an aperture 1308 shaped to receive a light bulb base therethrough. In an additional embodiment, there may be provided a spring 1210, 1212 corresponding to each of the arms 1304, 1306, respectively. The springs 1310, 1312 may be operable to provide a pushing force in a radially outward direction so as to engage sidewalls of a ceiling can for centering light bulb insertion as the user moves the light bulb toward the light socket in the ceiling can. More specifically, as the user moves the light bulb toward the light socket in the ceiling can, the springs' forces push the arms 1304, 1306 radially outward until the arms 1304, 1306 engage/touch the ceiling can sidewalls, thereby centering the light bulb as it is translated upward toward the light socket. In one embodiment, the radially outward directions of the springs' forces are directed in opposite directions. In another embodiment, there may be provided more than two arms 1304, 1306. In such an embodiment, there would also be additional springs such that one arm corresponds to one spring.

A novel and efficient centering guide has been disclosed in various non-limiting embodiments for light bulb insertion within a recessed ceiling can. Embodiments of the invention provide a light bulb base coupling member with a plurality of guide arms extending from the light bulb base coupling member, the plurality of guide arms operably configured to guide a light bulb toward a center of a recessed ceiling can during installation of the light bulb within the recessed ceiling can. In addition, embodiments of the invention provide the light bulb base coupling member shaped as a collar defining an aperture through which the light bulb base is easily inserted for selectively coupling of the centering guide with the light bulb. Further, embodiments of the centering guide include guide arms made of a resilient material and provided in varying lengths to accommodate use with ceiling cans of varying diameters.

What is claimed is:

1. A centering guide for light bulb insertion within a recessed ceiling can, the centering guide comprising:
a light bulb base coupling member operably configured to selectively couple the light bulb base coupling member to a light bulb base of a light bulb; and
at least one guide arm coupled to the light bulb base coupling member and operably configured to center the light bulb as the light bulb is translated in a vertical direction toward a light socket associated with a recessed ceiling can when the light bulb base coupling member is coupled to the light bulb base of the light bulb, the at least one guide arm:
having a proximal end coupled to the light bulb base coupling member;
having a distal end opposite the proximal end; and
having a length extending between the proximal end and the distal end, the length extending radially outward from light bulb base coupling member.

2. The centering guide in accordance with claim 1, wherein:
the light bulb base coupling member defines an aperture, the aperture sized and configured to selectively receive the light bulb base therethrough for selectively coupling the light bulb base coupling member to the light bulb base.

3. The centering guide in accordance with claim 1, wherein:
the at least one guide arm includes a plurality of guide arms.

4. The centering guide in accordance with claim 3, wherein:
each of the plurality of guide arms are fixedly attached to the light bulb base coupling member.

5. The centering guide in accordance with claim 3, wherein:
the length of at least one of the plurality of guide arms is less than the length of another one of the plurality of guide arms.

6. The centering guide in accordance with claim 3, wherein:
the plurality of guide arms includes a first subset of guide arms with a corresponding first length, a second subset of guide arms with a corresponding second length, and the first length different from the second length.

7. The centering guide in accordance with claim 6, wherein:
the plurality of guide arms are arranged such that the guide arms of the corresponding first length alternate with the guide arms of the corresponding second length along the light bulb base coupling member.

8. The centering guide in accordance with claim 3, wherein:
the light bulb base coupling member is circular and at least a portion of each of the plurality of guide arms are disposed along an outer circumference of the light bulb base coupling member and extending radially outward therefrom.

9. The centering guide in accordance with claim 3, wherein:
the plurality of guide arms are disposed along an outer perimeter of the light bulb base coupling member and equally spaced apart from one another along said outer perimeter.

10. The centering guide in accordance with claim 1, wherein:
the distal end is operably configured as a recessed ceiling can sidewall engaging end.

11. The centering guide in accordance with claim 1, wherein:
the at least one guide arm is of a resilient material.

12. The centering guide in accordance with claim 1, wherein:
the centering guide is sized to include a width that is substantially the same as a width of the recessed ceiling can.

13. The centering guide in accordance with claim 1, wherein:
the length of the at least one guide arm extends radially outward in a substantially linear direction within a horizontal plane when the guide arm is not in a flexed configuration.

14. The centering guide in accordance with claim 1, wherein:
an exterior surface of the at least one guide arm is substantially planar along its length.

15. A method of inserting a light bulb into a light socket of a recessed ceiling can, the method comprising steps of:
providing, by a user, a centering guide including:
a light bulb base coupling member; and
a plurality of guide arms coupled to the light bulb base coupling member, each of the guide arms having a proximal end coupled to the light bulb base coupling member, a distal end opposite the proximal end, and a length extending between the proximal end and the distal end;
coupling, by the user, the centering guide to a light bulb base of a light bulb;
translating, by the user and after coupling the centering guide to the light bulb base of a light bulb, the light bulb coupled to the centering guide in a vertical direction toward a light socket associated with a recessed ceiling can; and
during the translating step, distal ends of at least a first one and a second one of the plurality of guide arms engaging an interior surface of a sidewall of the recessed ceiling can so as to guide the user in a radial direction toward a central axis of the recessed ceiling can.

16. The method in accordance with claim 15, wherein:
the providing step includes providing the light bulb base coupling member defining an aperture; and
the coupling step includes inserting, by the user, the light bulb base through the aperture.

17. The method in accordance with claim 15, further comprising a step of:
during the translating step, distal ends of at least a third one and a fourth one of the plurality of guide arms flexing as a result of engaging the interior surface of the sidewall of the recessed ceiling can.

18. The method in accordance with claim 15, further comprising a step of:
coupling, by the user, the light bulb to the light socket by screwing the light bulb base into the light socket.

19. The method in accordance with claim 15, further comprising a step of:
providing a length of at least one of the plurality of guide arms as less than a length of another one of the plurality of guide arms.

20. The method in accordance with claim 15, wherein:
the providing step includes providing the light bulb base coupling member defining an aperture; and
the coupling step includes sliding, by the user, in a linear direction, the light bulb base through the aperture defined by the light bulb base coupling member.
